(19) United States
(12) Patent Application Publication
(10) Pub. No.: US 2004/0158706 A1
(43) Pub. Date: Aug. 12, 2004

(54) System, method, and device for facilitating multi-path cryptographic communication

(76) Inventors: Haruo Moritomo, Fuchu (JP); Yasuaki Tashiro, Odawara (JP); Akihiko Taniguchi, Yokohama (JP); Nobuo Shirai, Hino (JP)

Correspondence Address: KATTEN MUCHIN ZAVIS ROSENMAN, 575 MADISON AVENUE, NEW YORK, NY, 10022-2585, US

(21) Appl. No.: 10/687,563

(22) Filed: Oct. 16, 2003

(30) Foreign Application Priority Data
Oct. 16, 2002 (JP) 2002-301317

(51) Int. Cl. H04L 9/00

(52) U.S. Cl. 713/153

(57) ABSTRACT

“A System, Method, and Device for Facillitating Multi-Path Cryptographic Communication” A system, method, and node device for cryptographic communication are disclosed. Cryptographic tunnels between a source and destination node having intermediate stops at one or more repeating nodes are used to send and receive encrypted packets. This method of cryptographic communication is the default route of message exchange and allows repeating nodes to decrypt and re-encrypt packets along the route. When cryptographic communication traffic at a repeating node exceeds or falls below a certain threshold value, a direct route cryptographic tunnel is established between a source and destination pair of nodes, thereby diminishing encryption and decryption process load at intermediate repeating nodes.

### BACKGROUND OF THE INVENTION

1. Field of Invention

The present invention relates generally to the field of cryptographic communication. More specifically, the present invention is related to policy implementation in cryptographic tunnel formation.

2. Discussion of Prior Art

Cryptographic communication is a means of establishing a private link between communicating parties. Cryptographic communications require a transmitting site to encrypt a message according a specific protocol and a receiving site to decrypt the message in accordance with the same protocol. Cryptographic communication for in an inverse direction is conducted in the same manner for two-way communications.

When cryptographic communication is required between two parties, a virtual private network (VPN) is formed via tunneling applications. The most widely known and implemented protocol for implementing a cryptographic tunnel is IPSec. This method, well known in the art of cryptographic communication, is described in Japanese Patent Application Publication No. Tokukai 2002-044141. In the case where intermediate nodes along the tunnel path perform repeating functions (e.g., a router), a tunnel is formed between the first site and the repeating node, and between the repeating node and the second site.

Since cryptographic tunnels are formed between adjacent communicating parties, the number of tunnels required to facilitate cryptographic message exchange increases in proportion to the square of the number of sites participating in cryptographic message exchange. For example, only one tunnel is necessary for communication between two sites but ten tunnels are required for communication between five sites. Accordingly, when each site establishes tunnels for all other communicating sites to connect to, it is necessary to set and maintain IPSec information associated with the formation and maintenance of these tunnels.

When cryptographic communication occurs along a path where a repeating node is situated, two or more tunnels will terminate or originate at a repeating node, thereby using the repeating node as an intermediate stop. This reference does not describe a cryptographic tunnel directly connecting communicating sites.

FIG. 1 illustrates a prior art example of cryptographic communication in a hub and spokes architecture where cryptographic tunnels terminate and originate at repeating nodes. In this example, cryptographic communication occurs between terminal 11 and terminal 31. A router 1 at site 1 having received packets destined for terminal 31 originating at terminal 11 encrypts received packets depending on a preset policy and transmits the encrypted packets to a router 2, a repeating node. Router 2 decrypts the received packets and then transfers these packets to site 2 after the re-encrypting the packets. At site 2, router 3 decrypts the packets and then transfers these packets to the terminal 31. In this manner, cryptographic communication is realized.

With regards to the formation of a cryptographic tunnel, two forms of cryptographic communication systems exist; one system allows an encrypted packet to be received before a cryptographic tunnel over which to transmit the packet is formed, and another system requires that a cryptographic tunnel be formed before the encrypted packet is received. In a hub and spoke architecture, it is preferable to create cryptographic tunnels between the repeating node and originating and terminating sites before an encrypted packet is received.

In the case where cryptographic tunnels are formed to directly connect sites, a Security Association Database (SAD) is used to store information about the formation and maintenance of the cryptographic tunnels. This database resides on sites through which or to which cryptographic tunnels run. The resources consumed by cryptographic tunnels formed by consulting an SAD are directly proportional to the number of cryptographic tunnels formed. In other words, cryptographic tunnels formed but not used in cryptographic message exchange wastes resources. In addition, this method is limited in that packets may not be transferred until the tunnel is formed in accordance with information stored in a database residing on the communicating site.

Moreover, cryptographic tunnels terminated by a repeating node place a heavy requirement load on the repeating node. Received packets must be decrypted and encrypted again in this node before they are transmitted. The encryption and decryption processes require a high performance node to process a large amount of cryptographic communication traffic. As networks grow larger and larger, the burden placed on a repeating node increases.

In order to form a cryptographic tunnel with the reception of an encrypted packet, a sequence of messages are exchanged and the packet to be encrypted is either queued or destroyed. Thus, network response to cryptographic communication is lowered.

Whatever the precise merits, features, and advantages of the above cited references, none of them achieves or fulfills the purposes of the present invention. An object of the present invention is to economically allocate resources used in association with the formation of cryptographic communication tunnels.

### SUMMARY OF THE INVENTION

The present invention includes a system, method, and node device for facilitating multi-path cryptographic communication via policy consultation. A system comprising start node, end node, and repeating node devices are used to facilitate cryptographic communication. Cryptographic tunnels between a source and destination node having intermediate stops at one or more repeating nodes are used to send and receive encrypted packets. This method of cryptographic communication is the default route of message exchange and allows repeating nodes to decrypt and re-encrypt packets along the route. When cryptographic communication traffic at a repeating node exceeds a certain threshold value, a direct route cryptographic tunnel is established between a source and destination pair of nodes, thereby diminishing encryption and decryption process load at intermediate repeating nodes. The decision to switch between a default route and a direct route is made by a router device. A router device used to form a cryptographic tunnel for a repeating node device includes a receiving unit over which encrypted packets are received; a first transmitting unit by which re-encrypted packets are passed to a first cryptographic tunnel, and a second transmitting unit by which re-encrypted packets are passed to a second cryptographic tunnel. This decision is made by consulting a plurality of databases comprising a Security Policy Database (SPD), a Security Association Database (SAD), and a Default/Direct Table (DDT). This decision is also facilitated by a statistic concerning the amount cryptographic communication traffic passing through a repeating node, which is determined counting a number of packets transmitted via a certain route over a specified unit of time.

### BRIEF DESCRIPTION OF THE DRAWINGS

FIG. 1 illustrates prior art cryptographic communication in a hub and spokes architecture

FIG. 2 illustrates a router device and associated internal units

FIG. 3 illustrates a switch between the default route and direct route in the present invention

FIG. 4 illustrates the setting of the Security Policy Database of the present invention

FIG. 5 illustrates the setting of the Default/Direct Table of the present invention

FIG. 6 illustrates the setting of the Security Association Database of the present invention

FIG. 7 is a process flow diagram of IPSec processing in a router device of the present invention

FIG. 8 is a process flow diagram of steps S2 and S3 of IPSec processing in the present invention

FIG. 9 is a process flow diagram of the traffic-monitoring unit of the present invention;

FIG. 10 is a process flow diagram to cancel the direct route tunnel of the present invention

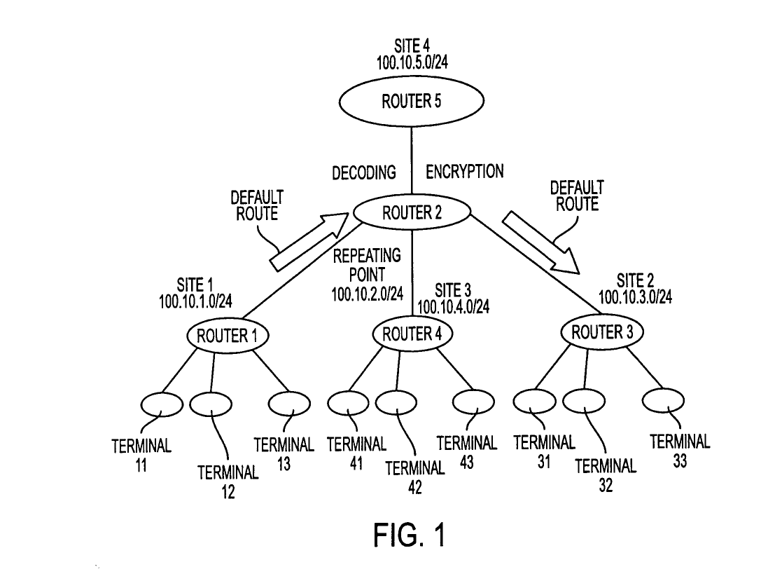

### DESCRIPTION OF THE PREFERRED EMBODIMENTS

While this invention is illustrated and described in a preferred embodiment, the invention may be produced in many different configurations. There is depicted in the drawings, and will herein be described in detail, a preferred embodiment of the invention, with the understanding that the present disclosure is to be considered as an exemplification of the principles of the invention and the associated functional specifications for its construction and is not intended to limit the invention to the embodiment illustrated. Those skilled in the art will envision many other possible variations within the scope of the present invention.

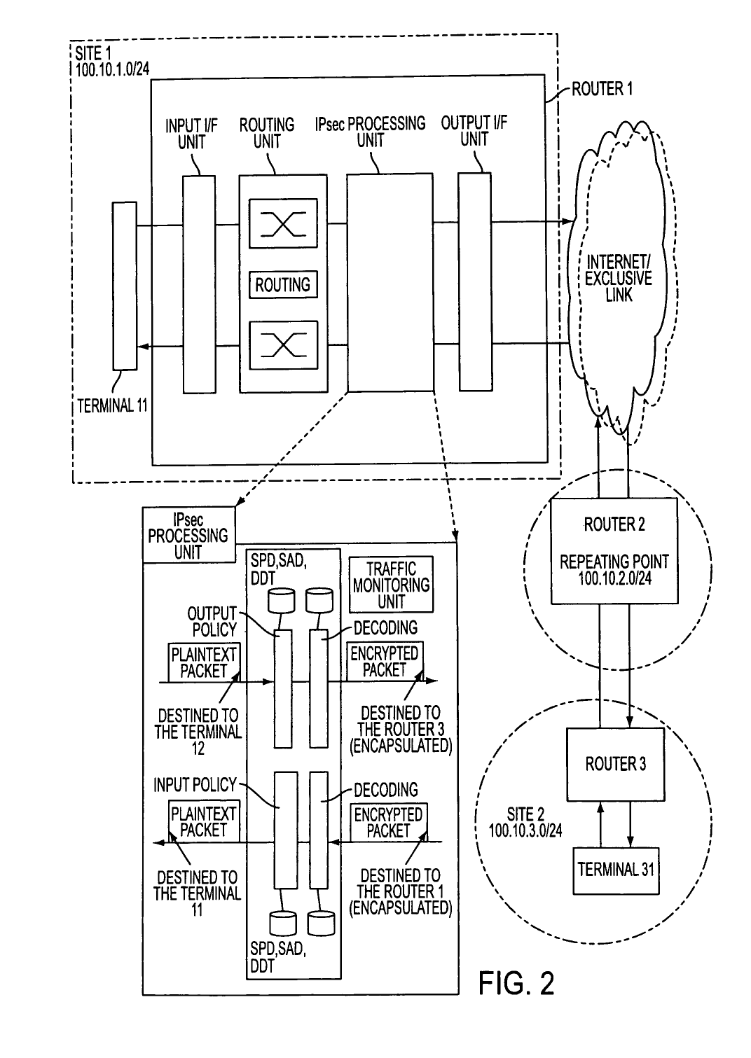

Referring now to FIG. 2, a plaintext packet transmitted from terminal 11 to terminal 31 is input to an input I/F unit of router 1 of site 1. Packets are transmitted to a repeating node based on consultation of databases also located on a router 1. A packet input to an input I/F unit is routed based on a destination IP address (in this figure the IP address of terminal 31) included in a packet header via a routing unit and is then transferred to an IPSec processing unit, both units being a part of router 1. An IPSec processing unit located within a router searches a security policy database (SPD) and security association database (SAD) based on destination address information taken from the header of a plaintext packet and determines an endpoint IP address, a transfer destination address, a link number, and an encryption or no-encryption policy. Based on this determination, a repeating node to which the packet will be transmitted on an outgoing link is determined. An SPD stores security policy information for cryptographic communication between sites.

When cryptographic communication traffic increases, the load associated with encryption and decryption processes also increases in a repeating node. In order to reduce the burden on a repeating node, a direct route cryptographic tunnel for direct connection between site 2 (terminal 31) and site 1 (terminal 11) is formed if encryption and decryption process load at a repeating node exceeds a threshold value. A direct route cryptographic tunnel for direct connection is formed after consultation of a DDT, an SAD, and an SPD.

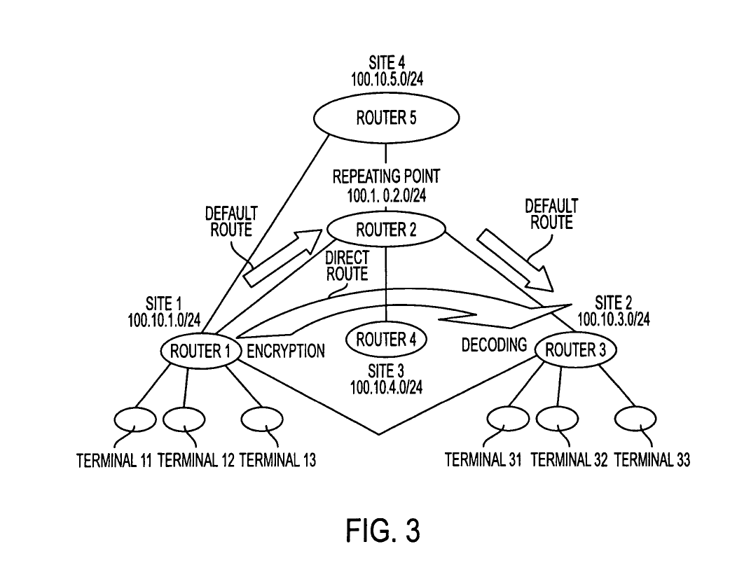

In FIG. 3, a default route is shown to be selected for the transmission of cryptographic communication between terminal 11 and terminal 31. When cryptographic communication traffic travels along a default route, encryption and decryption processes take place in a repeating node. Here, a default route means a preset route for cryptographic communication that forms cryptographic tunnels terminating and originating at a repeating node.

Also shown in FIG. 3, a new cryptographic tunnel is set between router 1 and router 3 while communication occurs between terminal 31 and terminal 11. Router 1 switches a cryptographic tunnel to a direct route after a default route. With a direct route a cryptographic tunnel directly connects a start point node and an end point node. When a cryptographic tunnel route is switched from a default route to a direct route, a repeating node no longer performs encryption and decryption processes, thus reasonable assignment of resources can be realized. In addition, encryption and decryption process load in a repeating node can also be eased. A new direct route cryptographic tunnel may be set via the same default route or via an alternative route.

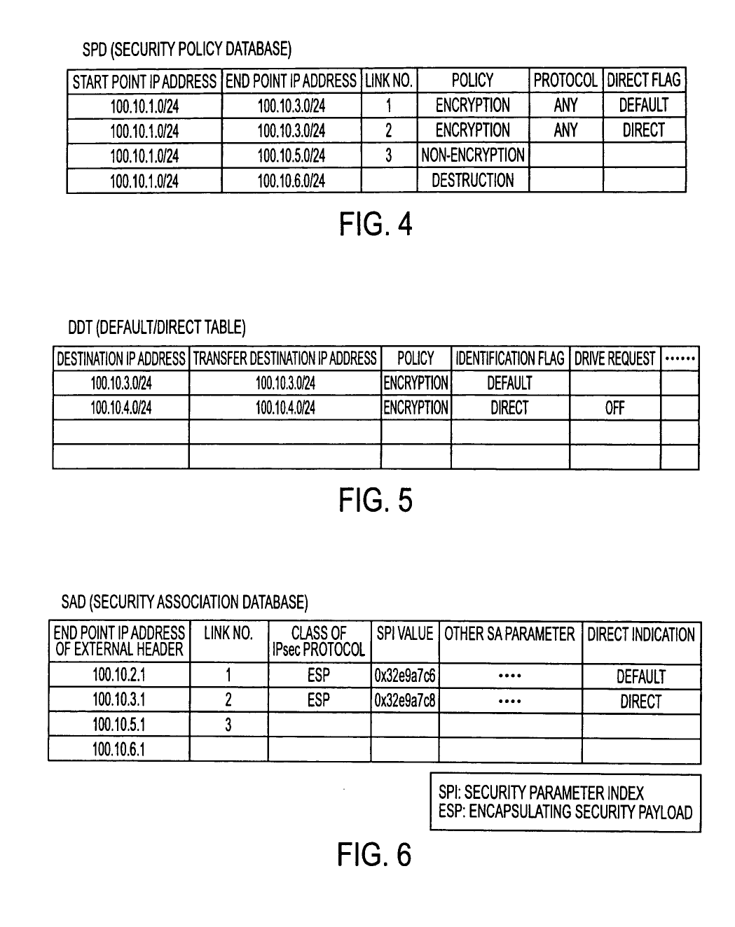

In FIG. 4, a start point IP address indicates the domain in which a site resides. In this figure, the IP address of terminal 11 is shown to be 100.10.1.120. When the IP address of a start point in an SPD is defined as 100.10.1.0/24, it satisfies the condition required of an IP address of a start point. That is, the portion of an IP address following the dotted decimal notation, in this case, 24, specifies an address where 24 bits from the leading bit are matched. If the last eight bits are not matched, an IP address is considered as the same IP address. For example, if packets are transmitted between terminal 31 and terminal 11, a destination address to the terminal 31 corresponds to the EP address of the end point shown in the SPD shown in FIG. 4. When a plaintext packet is received by a IPSec processing unit, a start point and end point EP address are extracted from the header of the plaintext packet and are used to key a search of an SPD. Based on a search of the SPD, the manner in which subsequent transmittal of the packet takes place is determined. In specific, a consultation of an SPD determines a transfer destination address, a link number, an encryption, no-encryption, or destruction policy, a protocol to conform to, and a direct route or default route flag.

A packet having a start point address of 100.10.1.11 and an end point address of 100. 10.3.31 is processed according to security policy information in the first line of the SPD shown in FIG. 4. In the example shown, the security policy indicates that the output link number is 1 and any type of encryption and protocol may be used. In FIG. 3, a route via a repeating node (in this case, router 2) is shown as a default route. In this case, a plurality of routers may be used and a plurality of alternative routes may also be selected. Any device performing encryption, decryption, and destruction processes consult an SPD by determining security policy information based on a start point [P address and an end point IP address in a packet. The type of route selected for cryptographic communication (i.e. default or direct route) is chosen by selecting a link number on which to transmit a packet.

In FIG. 5, a DDT is shown indicating columns for: destination EP address, transfer destination IP address, policy, identification flag, and drive request. A destination IP address is assigned to a domain or a terminal. A transfer destination IP address specifies an address of the next router to which the packet is transferred or an IP address assigned to a domain. A policy parameter refers to a policy for the encryption of a packet. Identification flag refers to a whether a default route or a direct route will be used for cryptographic communication. An end point IP address is assigned to an interface card of an end point router device.

In FIG. 6, an example of a Security Association Database (SAD) is shown. An end point IP address indicates the end point IP address of the external header of an encapsulated packet. A link number indicates a link number selected by the routing unit in a router device over which to transmit an outgoing packet. Class of IPSec protocol designates a protocol for cryptographic communication between two sites. In this figure, an Encapsulating Security Payload (ESP) protocol is shown. A Security Parameter Index (SPI) is used to identify a Security Association (SA). Direct indication indicates whether cryptographic communication occurs via a default route or a default route.

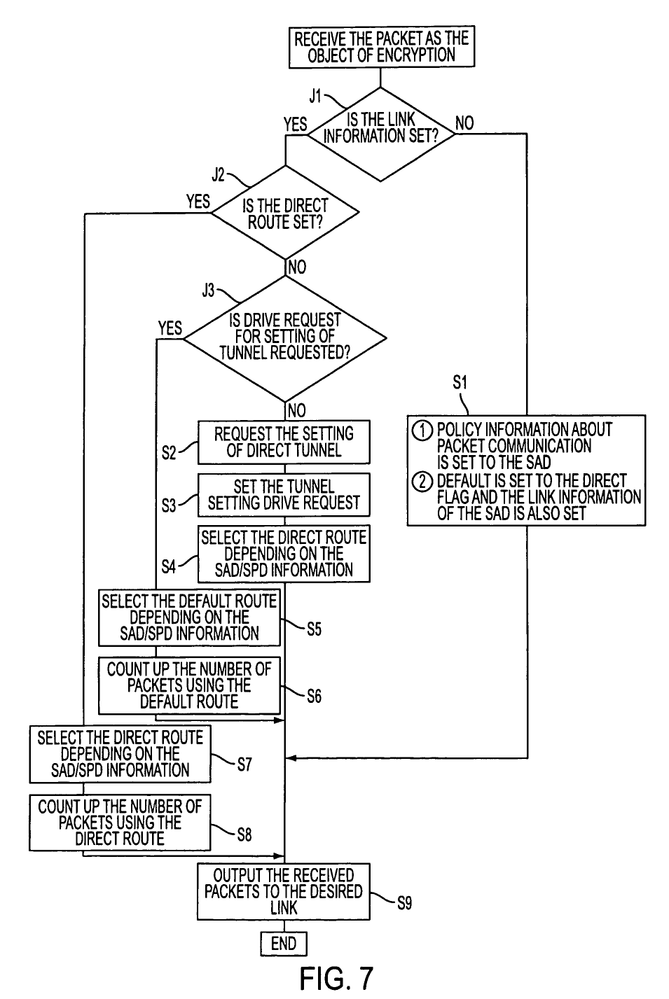

FIG. 7 illustrates a process flow diagram for when an encrypted packet is received in an IPSec processing unit of a router. In step J1, a destination address and a source address are extracted from a received encrypted packet. An SPD is consulted using extracted destination address and source address information as search keys. For example, when a destination address is 100.10.3.31 and a source address is 100.10.1.11, a link number, an encryption policy, protocol, and direct flag may be obtained by searching an SPD illustrated in FIG. 4. Accordingly, using the exemplary addresses as search keys for the SPD shown in FIG. 4, the link parameter is determined to have a value and the process branches to step J2. However, if the link parameter has a null value or is not yet set, the process branches to step S1. The case where the process branches to step S1 will be described.

In the step S1, since information associated with a cryptographic tunnel is not yet set, a cryptographic tunnel terminating at a repeating node is formed and associated information is sent to an SPD, an SAD, and a DDT. Thereafter, the process branches to the step S9. The received packets are temporarily stored in a buffer or the like until a cryptographic tunnel is formed.

In FIGS. 4 through 6, it is assumed that a cryptographic tunnel is previously set (manually or automatically) with a certain terminal end point from a repeating node. It is preferable that a cryptographic tunnel is statically formed prior to packet reception for when a packet is to be transmitted via a default route.

Since link information is already set in step J2, reference is made to direct flag information corresponding to a received packet. When direct flag information indicates a default route, the process branches to the step J3. When direct flag information indicates a direct route, the process branches to step S7.

In step J3, it is determined whether a direct route cryptographic tunnel setting has been driven or not. Using a source address and destination address extracted from a received packet as search keys, a drive request flag corresponding to a received packet is obtained from a DDT. When the value of a drive request flag is set to “on”, it is determined that a request to set a cryptographic tunnel has already been made and the process branches to step S5. If the value of a drive request flag is set to “off”, the process branches to step S2.

In step S2, a request to form a cryptographic tunnel directly connecting a start point and an end point is made. Simultaneously, information associated with the formation and maintenance of a cryptographic tunnel is sent to an SAD, SPD, and a DDT. In step S3, a drive request flag for a DDT is updated to “on” for the recently formed cryptographic tunnel. In step S4, a default route is selected after a consultation of an SPD and an SAD. Thereafter, the process branches to step S9.

When a drive request flag for a DDT determined to be “on” as shown in step J3, the process branches to step S5. Here, a default route is selected after a consultation of an SPD and an SAD. A traffic per unit time statistic is also calculated by collecting the number of packets received per unit time via a default route. Thereafter, the process branches to step S9.

When a direct flag in an SPD is set to direct in step J2, the process branches to step S7. A direct route is selected by consulting an SPD and an SAD using the destination address of a received packet as a search key. A traffic per unit time statistic is also calculated by collected the number of packets received per unit time via a default route. Thereafter, the process branches to step S9.

In step J1, if link information is not yet set, the process branches to step S1.

In step S1, control information related to an encrypted packet communication is sent to an SAD. In addition, a direct flag field in an SAD is set to default. Link information is also set. Thereafter, the process branches to step S9.

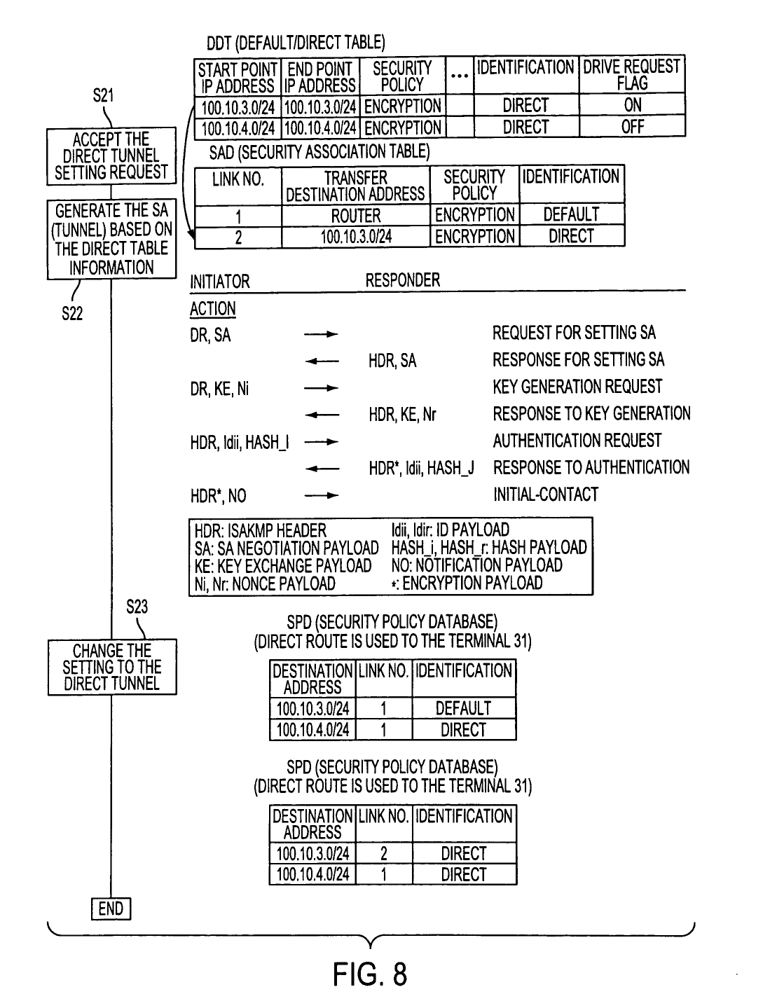

In step S9, a received packet is output on a desired link. FIG. 8 illustrates details of steps S2 and S3 in a process flow diagram for when an encrypted packet is received. In this figure, steps S21 through S23 correspond to the steps S2 through S3 of FIG. 7. When a directly connected cryptographic tunnel setting is requested in step S2, the process branches to step S21.

Steps S21 through S23 in FIG. 8 are a more detailed view of steps S2 and S3 in FIG. 7. In FIG. 8, step S21 in the process flow diagram indicates an acceptance of an direct cryptographic tunneling request. In step S22, information in a DDT is set based on a start point IP address and an end point IP address extracted from a received packet.

Next, information about a cryptographic tunnel is sent to an SAD by generating security association (SA) information based on setting information used to form a direct tunnel. An example of the sequence of messages exchanged during the formation of a cryptographic tunnel is illustrated in FIG. 8. In this example, a protocol sequence is described for an Initiator, a Responder, and an Action. The sequence describes procedures up to an authentication response and initial contact from a request for setting an SA parameter.

In the step S23, a default route is used for transferring a received packet is changed to follow a direct route. In practice, to effect a change of route, a link number in an SPD can be overwritten and a class field can be changed to direct.

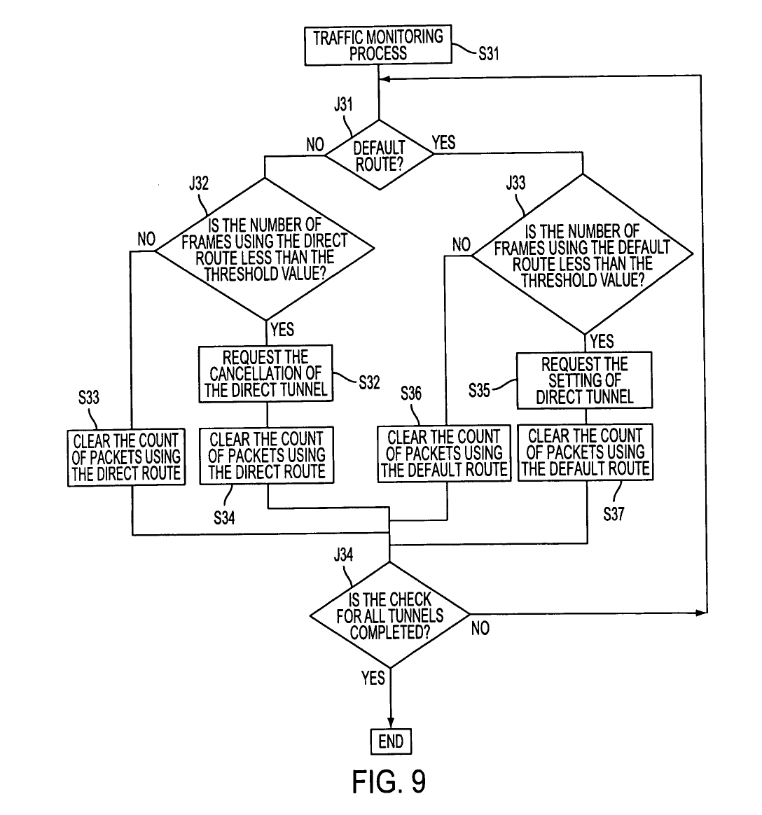

FIG. 9 illustrates a process flow diagram of a traffic monitoring process. In steps S6 and S8 of FIG. 7, a number of packets received per unit time are counted, both for packets received via direct route and default route cryptographic communication. A traffic-monitoring unit shown in the FIG. 2 monitors the counted values. A traffic-monitoring unit is provided within an IPSec processing unit of a router device.

Referring now to FIG. 9, in step S31, cryptographic communication traffic is collected for a preset time interval. In step J31, the traffic-monitoring unit refers to an SAD and determines whether the traffic collected is traffic flowing along a default route or a direct route by keying a search of a database using a link number on which current cryptographic traffic is being collected. In the case where a route is chosen to be a default route, the process branches to step J33. In the case of where the route is chosen to be a direct route, the process branches to step J32.

In step J32, when the number of packets received via direct route cryptographic communication per unit time is equal to or larger than a threshold value, a direct route continues to be used for each exchange of cryptographic communication and a direct route packet counter is cleared in step S8. Thereafter, the process branches to step J34.

In steps S32 and S34, a request for canceling the use of a direct route is issued. In step S8, the packet counter is cleared to zero. Thereafter, the process branches to the step J34. In step J33, when the number of packets transmitted along a default route counted during a preset time interval is equal to or larger than the threshold value, a default route is selected and a default route packet counter is cleared to zero in step S6. Thereafter, the process branches to the step J34.

In steps S35 and S37, a request for canceling the use of a default route is issued. When a default route is set previously, dynamic cancellation is not necessary. Next, a packet counter is cleared to zero in step 6. Thereafter, the process branches to step J34. In step J34, an SAD is consulted to confirm whether the process has been performed for all cryptographic tunnels or not. When the process has been performed for all cryptographic tunnels, the process is terminated.

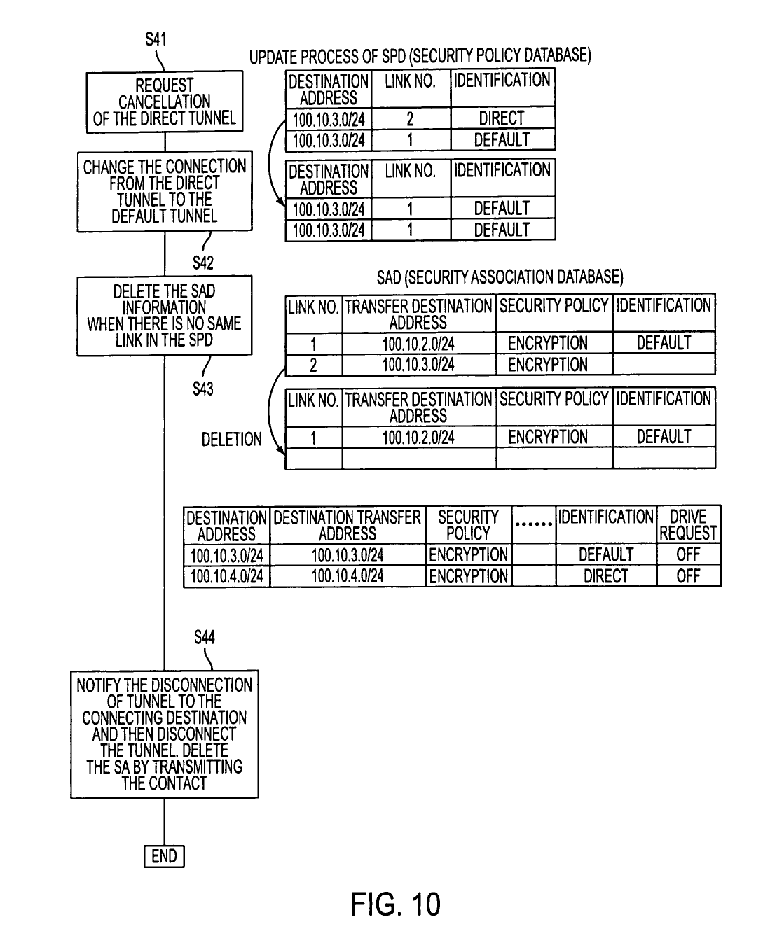

FIG. 10 illustrates a process diagram flow for canceling the current direct or default route choice as a more detailed view of steps S32 and S35 of FIG. 9. Shown in the figure, a request for canceling the setting of a direct route cryptographic tunnel is accepted in step S41. In this case, a destination address of a received packet is used to obtain information from an SPD about the cryptographic tunnels for which cancellation is requested.

In step S42, an SPD is consulted using a destination address extracted from an encrypted packet as a search key in order to cancel a direct route value of a direct indication parameter. The direct indication parameter in an SAD is changed to reflect a default route.

In step S43, a link number corresponding to the destination IP address for the cancelled direct route cryptographic tunnel is deleted from a corresponding SAD.

For 100.10.3.0/24, an identification parameter in a DDT is changed from a value of direct to a value of default and a drive request parameter is changed from a value of on to a value of off.

In step S44, a message is sent to notify the destination terminal of connection termination. Thereafter, the session is disconnected. An SA associated with a cryptographic tunnel is released by transmitting an initial contact message.

Additionally, the present invention provides for an article of manufacture comprising computer readable program code contained within implementing one or more modules to form, maintain, and switch between one or more cryptographic communication tunnels. Furthermore, the present invention includes a computer program code-based product, which is a storage medium having program code stored therein which can be used to instruct a computer to perform any of the methods associated with the present invention. The computer storage medium includes any of, but is not limited to, the following: CD-ROM, DVD, magnetic tape, optical disc, hard drive, floppy disk, ferroelectric memory, flash memory, ferromagnetic memory, optical storage, charge coupled devices, magnetic or optical cards, smart cards, EEPROM, EPROM, RAM, ROM, DRAM, SRAM, SDRAM, or any other appropriate static or dynamic memory or data storage devices.

Implemented in computer program code based products are software modules for: (a) initiating and canceling a cryptographic tunnel; (b) monitoring cryptographic traffic flow on a device; and (c) applying policy decisions to packet traffic.

### Conclusion

A system and method has been shown in the above embodiments for the effective implementation of a system, method, and device for facillitating multi-path cryptographic communication. While various preferred embodiments have been shown and described, it will be understood that there is no intent to limit the invention by such disclosure, but rather, it is intended to cover all modifications falling within the spirit and scope of the invention, as defined in the appended claims. For example, the present invention should not be limited by software/program, computing environment, or specific computing hardware.

The above enhancements are implemented in various computing environments. For example, the present invention may be implemented on a conventional IBM PC or equivalent, multi-nodal system (e.g., LAN) or networking system (e.g., Internet, WWW, wireless web). All programming and data related thereto are stored in computer memory, static or dynamic, and may be retrieved by the user in any of: conventional computer storage, display (i.e., CRT) and/or hardcopy (i.e., printed) formats.

1. A router device which can set a first cryptographic tunnel to a repeating node device, comprising:
a. a first unit to receive encrypted packets for a terminal;
b. a second unit to transmit said encrypted packets through a first cryptographic tunnel for said terminal to a repeating node; and
c. a third unit to form a second cryptographic tunnel between said router device and an end node device when traffic of said encrypted packets has exceeded a first threshold value.

2. A router device, as per claim 1, further comprising an input I/F unit, a routing unit, a IPSec processing unit, and an output I/F unit.

3. A router device, as per claim 2, wherein said IPSec processing unit further comprises an Security Policy Database (SPD), an Security Association Database (SAD), a Default/Direct (DDT), and a traffic-monitoring unit.

4. A router device, as per claim 3, wherein said cryptographic tunnel is formed by consulting an SPD, an SAD, and a DDT.

5. A router device, as per claim 3, wherein said SPD stores security policy information comprising: a link number, an encryption policy, a protocol, and a direct flag and is searched using a start point IP address and an end point IP address extracted from a packet.

6. A router device, as per claim 4, wherein said first and second cryptographic tunnels are selected by selecting a link number.

7. A router device, as per claim 4, wherein said SPD comprises encryption policy further comprising an encryption, non-encryption, and destruction policy.

8. A router device, as per claim 3, wherein said SAD stores information comprising: an end point IP address, a link number, class of EPSec protocol, an SPI value, Security Association parameters (SA) parameters, and a direct indication and is searched using an end point IP address.

9. A router device, as per claim 3, wherein said traffic-monitoring unit
a. determines whether packets are transferred over a default or direct route cryptographic tunnel,
b. if packets are transferred over a default route cryptographic tunnel
i. said traffic-monitoring process counts the number of packets received over said cryptographic tunnel during a preset amount of time,
ii. if the number of packets counted during said preset amount of time is below a threshold value, a direct route cryptographic tunnel connection request is set and a default route packet counter is cleared, or
iii. if the number of packets counted during said preset amount of time is equal to or above said threshold value, said default route packet counter is cleared, and
c. If packets are transferred over a direct route cryptographic tunnel
i. said traffic-monitoring process counts the number of packets received over said cryptographic tunnel during a preset amount of time,
ii. if the number of packets counted during said preset amount of time is below a threshold value, direct route packet counter is cleared, or
iii. if the number of packets counted during said preset amount of time is equal to or above said threshold value, said direct route packet counter is cleared, and a default route cryptographic tunnel connection request is set.

10. A router device, as per claim 9, wherein said direct route cryptographic tunnel connection request further comprises steps of:
a. updating an SPD by changing an identification parameter to have a direct route value,
b. deleting information from an SAD where a link number corresponding to a said cryptographic connection is used to identify a row in said SAD to delete, and
c. sending a message to provide notification of cryptographic tunnel connection termination.

11. A router device, as per claim 8, wherein said security association database (SAD) indicates a direct or a default route corresponding to a first and second cryptographic tunnel, respectively.

12. A router device, as per claim 3, wherein said DDT stores information comprising: a destination IP address, a transfer destination IP address, an encryption policy, an identification flag, and a drive request and is searched using a destination IP address.

13. A router device, as per claim 1, wherein said first cryptographic tunnel is switched to said second cryptographic tunnel when traffic through said first cryptographic tunnel exceeds a first threshold value.

14. A router device, as per claim 13, wherein said switched second cryptographic tunnel is switched back to said first cryptographic tunnel when traffic through said second cryptographic tunnel is lower than a second threshold value.

15. A router device, as per claim 1, further comprising a fourth unit to include information indicative of a request to switch between said first cryptographic tunnel and said second cryptographic tunnel to perform a switching process between said first cryptographic tunnel and said second cryptographic tunnel.

16. A cryptographic communication system having a repeating node device, a start node device which can set a first cryptographic tunnel to said repeating node device, and an end node device, comprising:
a. a first node device comprising:
i. a first unit to receive packets for a terminal;
ii. a second unit to transmit the encrypted received packets through the first cryptographic tunnel; and
iii. a third unit to form a second cryptographic tunnel between the first node device and the end node device when traffic of the encrypted received packets has exceeded a first threshold value;
b. said repeating node device to decrypt a received encrypted packets from said first node and transmit received encrypted packets to said terminal; and
c. the end node device to decode the received encrypted packets and transmit the received encrypted packets to the terminal.

17. A method for cryptographic communication comprising:
a. receiving packets for a terminal at a first node;
b. transmitting the encrypted received packets to a repeating node over a first cryptographic tunnel;
c. decoding the encrypted received packet at the repeating node;
d. transmitting the encrypted decoded-packet to an end node; and
e. forming a second cryptographic tunnel between a start node and an end node when received packet traffic transferred over a first cryptographic tunnel has exceeded the first threshold value.
